(19) United States
(12) Patent Application Publication
(10) Pub. No.: US 2023/0037351 A1
(43) Pub. Date: Feb. 9, 2023

(54) LIGHT STRING STRUCTURE

(71) Applicant: Dongguan City Rainmin Intelligent Technology Limited, Guangdong (CN)

(72) Inventor: XIAO YAN LIU, Guangdong (CN)

(73) Assignee: Dongguan City Rainmin intelligent Technology Limited, Guangdong (CN)

(21) Appl. No.: 17/715,041

(22) Filed: Apr. 7, 2022

(30) Foreign Application Priority Data
Aug. 5, 2021 (CN) 202121813954.6
Jan. 19, 2022 (CN) 202220134375.7

(51) Int. Cl. F21S 4/10; F21V 23/00; F21V 21/008

(52) U.S. Cl. CPC F21S 4/10; F21V 21/008; F21V 23/002; F21V 23/007; F21Y 2115/10

(57) ABSTRACT

A light string structure includes a clip and a light source assembly. The clip is connected to the light source assembly, and a plurality of the light source assemblies are provided. Each light source assembly includes a light cover. The clip is arranged on a bottom portion or a side surface of the light cover. The clip and the light cover are integrally connected. The clip is elastic. The clip includes a clipping portion and inclined portions. An end of the clipping portion and the light cover are integrally connected. The clipping portion protrudes outwards and bends to form an arch-shaped concave portion. The inclined portions are respectively disposed at the end portions of the clipping portion and are integrally connected to the clipping portion. The inclined portions are respectively arranged inclined in directions opposite to bending directions of the clipping portion.

### CROSS-REFERENCE TO RELATED APPLICATION

This application claims the priority benefits of China application serial no. 202121813954.6 filed on Aug. 5, 2021 and no. 202220134375.7 filed on Jan. 19, 2022. The entirety of each of the above-mentioned patent applications is hereby incorporated by reference herein and made a part of this specification.

### BACKGROUND

### Technical Field

The disclosure relates to the technical field of light string installation, and in particular, to a light string structure.

### Description of Related Art

A light-emitting diode (LED) light string is generally formed by a plurality of light source bodies and a wire, and the wire connects the light source bodies into a string to form a light string. During the installation process of the LED light string, screw fixing or binding fixing is generally adopted to fix and install multiple light source bodies, such that the LED light string is placed in a desired light-emitting path. Alternatively, each light source body is fixedly installed by fitting in a groove for fixing, so that the LED light string is in a linear shape or other shapes. When the LED light string needs to be replaced, the disassembly and assembly operation of the former requires much effort, but in the latter method, the entire groove needs to be disassembled before the light string can be replaced. The groove is then re-installed after the replacement is completed, which is inconvenient in practical use.

### SUMMARY

The disclosure provides a light string structure in which an entire light string may be independently disassembled, assembled, and replaced, such that the light string may be pressed/pulled out with a little force during assembly/disassembly and exhibits a beneficial effect of being convenient to operate, and the problems mentioned in the related art may thus be solved.

To achieve the above, the following technical solutions are provided by the disclosure.

The disclosure provides a light string structure including a clip and a light source assembly. The clip is connected to the light source assembly, and a plurality of the light source assemblies are provided. Each of the light source assemblies includes a light cover. The clip is arranged on a bottom portion or a side surface of the light cover. The clip and the light cover are integrally connected. The clip is elastic. The clip includes a clipping portion and inclined portion. An end of the clipping portion and the light cover are integrally connected. The clipping portion protrudes outwards and bends to form an arch-shaped concave portion. The inclined portions are respectively disposed at end portions of the clipping portion and are integrally connected to the clipping portion. The inclined portions are respectively arranged inclined in directions opposite to bending directions of the clipping portion.

In an embodiment of the disclosure, the light source assembly further includes a printed circuit board (PCB) and at least one light bead. The PCB is connected in the light cover. The light bead is connected onto the PCB.

In an embodiment of the disclosure, the clipping portion is elastic, and an end surface of an opening of the clipping portion is C-shaped.

In an embodiment of the disclosure, each inclined portion and the clipping portion form an included angle.

In an embodiment of the disclosure, the light cover is provided with a light source installation chamber and a wire outlet. The light source installation chamber communicates with the wire outlet. Both the PCB and the light bead are installed in the light source installation chamber.

In an embodiment of the disclosure, the light cover is a transparent or matte light cover, and the light cover has a square, round, oval, or arched shape.

Compared to the related art, beneficial effects of the disclosure include the following.

In the light string structure provided by the disclosure, the clip may be clipped on other bases, clipping seats, or steel wire, and in this way, the light source assemblies is fixed, and installation of the light string is completed. The entire light string may be independently disassembled, assembled, and replaced. When being required to be assembled/disassembled, the light string may be slightly pressed/pulled out with a little force and thus may be conveniently operated.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a light string structure according to the disclosure.

FIG. 2 is a three-dimensional view of the light string structure according to the disclosure.

FIG. 3 is a side view of the light string structure according to the disclosure.

FIG. 4 is a schematic view of an internal structure of the light string structure according to the disclosure.

FIG. 5 is a schematic view of the light string structure according to embodiment 2 of the disclosure.

FIG. 6 is a side view of the light string structure in FIG. 5.

FIG. 7 is a cross-sectional view of FIG. 6 taken along A-A.

### DESCRIPTION OF THE EMBODIMENTS

The technical solutions in the embodiments of the disclosure will be clearly and completely described below with reference to the accompanying drawings in the embodiments of the disclosure. Obviously, the described embodiments are only a part of the embodiments of the disclosure, but not all of the embodiments. Based on the embodiments of the disclosure, all other embodiments obtained by a person having ordinary skill in the art without any creative effort fall within the protection scope of the disclosure.

### Embodiment One

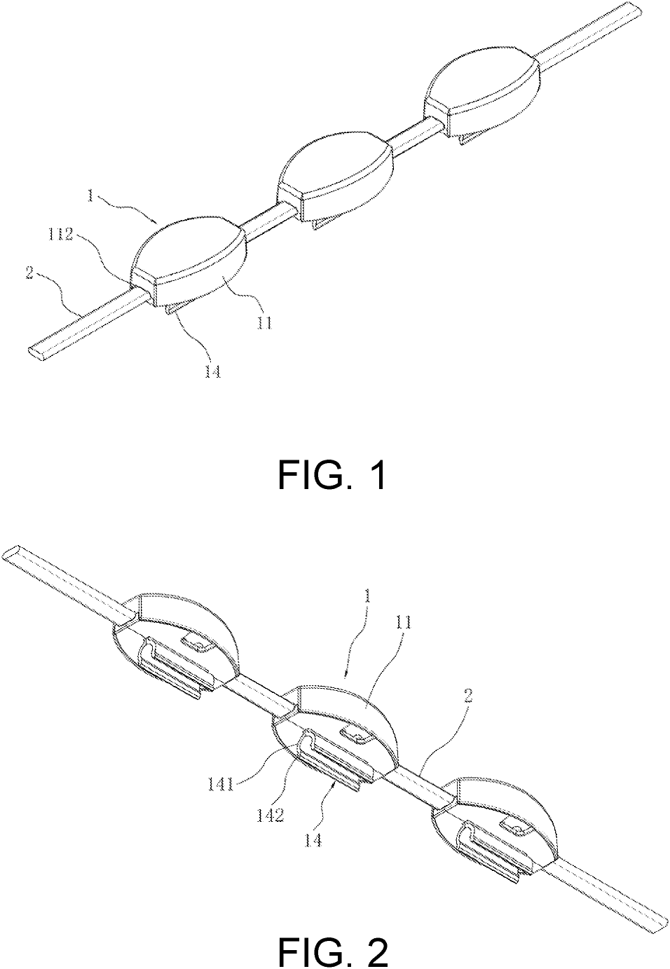

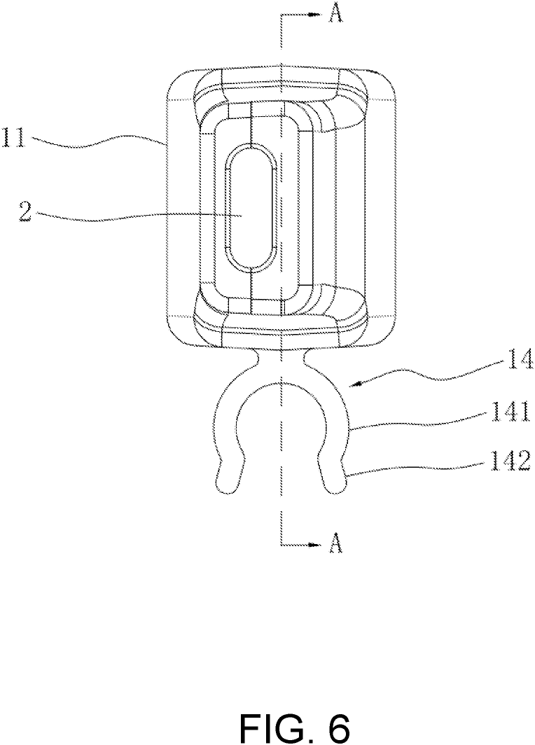

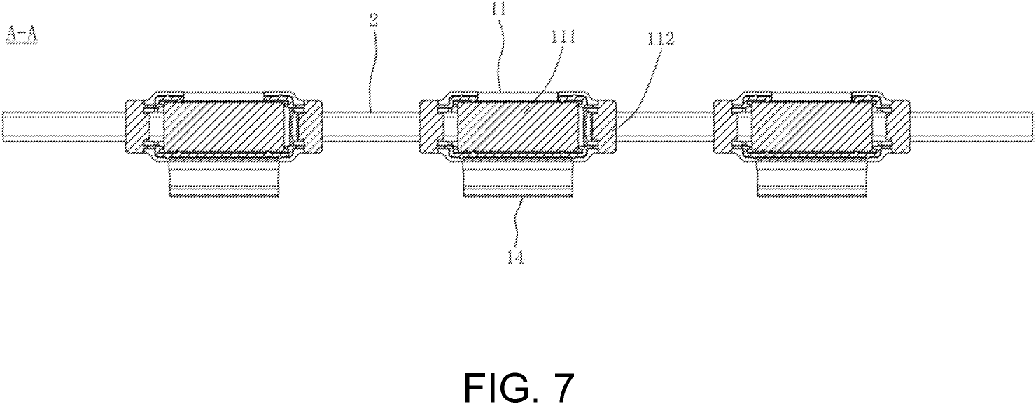

With reference to FIG. 1 to FIG. 7, in the embodiments of the disclosure, a light string structure is provided. With reference to FIG. 1 and FIG. 2, the light string structure includes a clip 14 and a light source assembly 1. The clip 14 is connected to the light source assembly 1, and a plurality of the light source assemblies 1 are provided. The light source assemblies 1 are sequentially connected by a wire 2. Each of the light source assemblies 1 includes a light cover 11. The clip 14 is arranged on a bottom portion or a side surface of the light cover 11. The clip 14 and the light cover 11 are integrally connected. The clip 14 is elastic. The clip 14 includes a clipping portion 141 and inclined portions 142. An end of the clipping portion 141 and the light cover 11 are integrally connected. The clipping portion 141 protrudes outwards and bends to form an arch-shaped concave portion, and an inner side of the arc-shaped concave portion abuts against a base or a clipping seat. The inclined portions 142 are respectively disposed at end portions of the clipping portion 141 and are integrally connected to the clipping portion 141. The inclined portions 142 are respectively arranged inclined in directions opposite to bending directions of the clipping portion 141. With reference to FIG. 4, the light source assembly 1 further includes a printed circuit board (PCB) 12 and a light bead 13. The PCB 12 is fixedly connected in the light cover 11. At least one light bead 13 is provided. The light bead 13 is welded to the PCB 12. Both the light bead 13 and the wire 2 are electrically connected to the PCB 12. The clip 14 is integrally connected to the light cover 11. In the light string structure provided by the disclosure, the clip 14 may be clipped on other bases, clipping seats, or steel wire, and in this way, the light source assembly 1 is fixed, and installation of a light string is completed. The entire light string may be independently disassembled, assembled, and replaced. When being required to be assembled/disassembled, the light string may be pressed/pulled out with a little force and thus may be conveniently operated.

In the embodiments of the disclosure, with reference to FIG. 1 and FIG. 2, the light cover 11 is a transparent or matte light cover, and the light cover 11 has an arched shape with chamfered corners. The shape of the light cover 11 may be selected according to actual needs and is not particularly limited herein, for example, the light cover 11 may have square, round, oval, or arched shape. A light source emitted by the light bead 13 is transmitted through the transparent light cover 11 or the matte light cover 11.

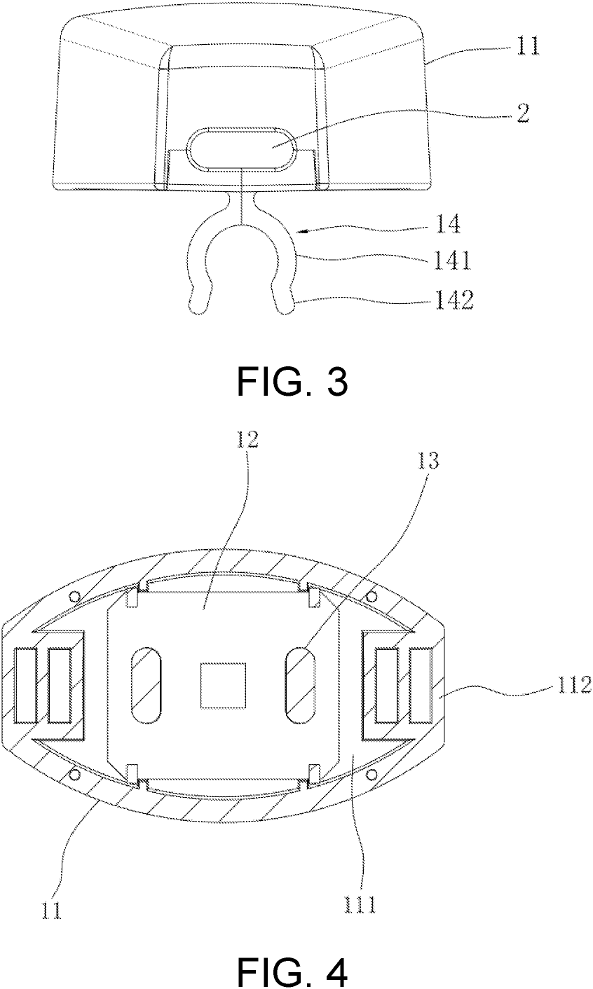

In a preferred embodiment of the disclosure, with reference to FIG. 2 and FIG. 3, an opening of the clip 14 is bent inwards to form the clipping portion 141 with an elastic force. The clipping portion 141 is elastic, and an end surface of an opening of the clipping portion 141 is C-shaped. Further, both end portions of the clip 14 are fixedly connected to the inclined portions 142, and the inclined portions 142 are respectively arranged inclined in directions opposite to the bending directions of the clipping portion 141. The inclined portions 142 and the clipping portion 141 are integrally formed, and each of the inclined portions 142 and the clipping portion 141 form an included angle. The inclined portions 142 enable the clip 14 to be conveniently clipped with the base, the clipping seat, or a steel wire rope. During installation, the clip 14 is pressed against the clipping seat or the base, and the clipping portion 141 is thus in contact with the clipping seat or the base. The clipping portion 141 slides inwards along the clipping seat or the base through tension provided by the clipping portion 141 until the clipping portion 141 is reset under the action of the elastic force and are clipped on the base or the clipping seat. When the clipping portion 141 slides along the clipping seat or the base towards the clipping seat or the base, the inclined portions 142 enable the tension of the clipping portion 141 to quickly find a force application point. In this way, even if the clip 14 is not completely aligned with the base or the clipping seat, the clip 14 may be smoothly clipped with the base or the clipping seat. In this embodiment, surfaces of the inclined portions 142 are coarse surfaces, and a frictional force which is generated after the clip 14 is clipped on the base or the clipping seat is thereby increased. As such, with absence of an external force, the light source assembly 1 may not slide on the base or the clipping seat, and the clip 14 is stably connected to the base or the clipping seat.

In a preferred embodiment of the disclosure, with reference to FIG. 4, the light cover 11 is provided with a light source installation chamber 111 and a wire outlet 112. The light source installation chamber 111 communicates with the wire outlet 112. Both the PCB 12 and the light bead 13 are installed in the light source installation chamber 111. Further, two wire outlets 112 are provided, and the two wire outlets 112 are respectively located at two sides of the light source installation chamber 111. The wire 2 passes through the light source installation chamber 111 through the wire outlets 112 and is connected to the PCB 12. The wire 2 is detachably connected to the wire outlets 112, so that the entire light string may be conveniently replaced.

### Embodiment Two

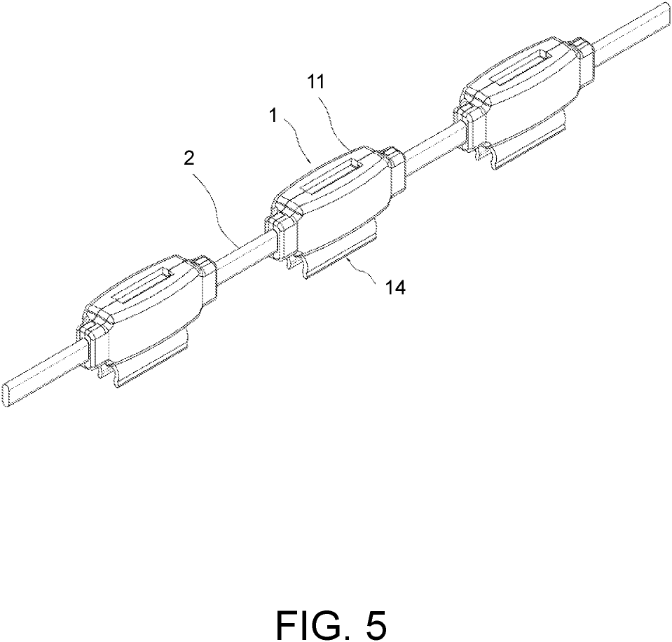

In the embodiments of the disclosure, with reference to FIG. 5 to FIG. 7, the clip 14 is connected to the side surface of the light cover 11. The light cover 11 is a transparent or matte light cover, and the light cover 11 is in the shape of a cuboid with chamfered corners. Both sides of the light cover 11 are flat. The light source emitted by the light bead 13 is transmitted from both sides of the light cover 11 and is suitable for side lighting.

In the light string structure provided by the disclosure, the clip 14 may be clipped on other bases or clipping seats, and in this way, the light source assembly 1 is fixed, and installation of the light string is completed. The entire light string may be disassembled and assembled together. When being required to be assembled/disassembled, the light string may be pressed/pulled out with a little force and thus may be conveniently operated.

Although the present disclosure is described in detail with reference to the foregoing embodiments, a person having ordinary skill in the art can still modify the technical solutions described in the foregoing embodiments or perform equivalent replacements for some of the technical features. Any modification, equivalent replacement, improvement, etc. made within the spirit and principle of the disclosure shall be included in the protection scope of the disclosure.

What is claimed is:

1. A light string structure, comprising a clip and a light source assembly, wherein the clip is connected to the light source assembly, a plurality of the light source assemblies are provided, each of the light source assemblies comprises a light cover, the clip is arranged on a bottom portion or a side surface of the light cover, the clip and the light cover are integrally connected, the clip is elastic, the clip comprises a clipping portion and inclined portions, an end of the clipping portion and the light cover are integrally connected, the clipping portion protrudes outwards and bends to form an arch-shaped concave portion, the inclined portions are respectively disposed at end portions of the clipping portion and are integrally connected to the clipping portion, and the inclined portions are respectively arranged inclined in directions opposite to bending directions of the clipping portion.

2. The light string structure according to claim 1, wherein the light source assembly further comprises a printed circuit board (PCB) and at least one light bead, the PCB is connected in the light cover, and the light bead is provided and is connected onto the PCB.

3. The light string structure according to claim 1, wherein the clipping portion is elastic, and an end surface of an opening of the clipping portion is C-shaped.

4. The light string structure according to claim 1, wherein each inclined portion and the clipping portion form an included angle.

5. The light string structure according to claim 2, wherein the light cover is provided with a light source installation chamber and a wire outlet, the light source installation chamber communicates with the wire outlet, and both the PCB and the light bead are installed in the light source installation chamber.

6. The light string structure according to claim 1, wherein the light cover is a transparent or matte light cover, and the light cover has a square, round, oval, or arched shape.
